(19) United States
(12) Patent Application Publication
(10) Pub. No.: US 2026/0179094 A1
(43) Pub. Date: Jun. 25, 2026

(54) ADAPTIVE SECURITY AUTHENTICATION

(71) Applicant: PAYPAL, INC., San Jose, CA (US)

(72) Inventors: Vik Westermann, New York City, NY (US); Bashanta Dahal, Hayward, CA (US); Disa Alda Naomi, San Francisco, CA (US); Xiaohai Zhang, San Francisco, CA (US); Vaibhav Kapur, New York, NY (US)

(21) Appl. No.: 18/990,282

(22) Filed: Dec. 20, 2024

(51) Int. Cl. G06Q 20/40

(52) U.S. Cl. CPC G06Q 20/4016; G06Q 20/4015

(57) ABSTRACT

The disclosed computer-implemented method may include receiving transaction data of an online transaction that has a pending security authentication requirement and determining a risk score and a conversion score from the transaction data. The method may also include assessing combinations of authentication factors for the security authentication requirement based on applying the risk score and the conversion score to determine probabilities of the online transaction being completed with the combinations of the authentication factors. In addition, the method may further include requesting a combination of authentication factors, selected based on the assessing, to satisfy the security authentication requirement for the online transaction. Various other methods, systems, and computer-readable media are also disclosed.

### TECHNICAL FIELD

The present disclosure relates to computer security and user authentication.

### BACKGROUND

Computer networks allow various online transactions, such as financial transactions or other interactions involving digital access to resources. Ensuring the security of data and proper authorization for this digital access requires establishing and confirming the identity of the individual requesting the access before granting such access. The process of user authentication provides for this confirmation of user identity.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for adaptive security authentication.

FIG. 2 is a block diagram of an example network for adaptive security authentication.

FIG. 3 is a diagram of an example data flow architecture for adaptive security authentication.

FIG. 4 is a flow diagram of an example overall process for adaptive security authentication.

FIGS. 5A-C are flow diagrams of various example evaluation processes for adaptive security authentication.

FIGS. 6A-B are flow diagrams of various example recommendation processes for adaptive security authentication.

FIG. 7 is a flow diagram of an example method for adaptive security authentication.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

User authentication relates to verifying users and/or devices attempting to gain access to a computing resource, such as a user's account with an online service (e.g., a financial account). User authentication often involves identification (e.g., a user proving who they are), authentication (e.g., a user proving they are the user from the identification), and authorization (e.g., a user proving they are allowed to access the computing resource as requested). Several authentication factors are available, such as password-based authentication (e.g., requiring a user to provide a correct password), on-time passwords (OTP) (e.g., requiring a user to provide a code generated for the specific authentication event and may be delivered via a different communication channel), push notification (e.g., requiring a user to respond to a push notification on their mobile device to approve an access request), certificate-based authentication (e.g., requiring a user to provide a digital certificate that may be encrypted), token-based authentication (e.g., requiring a user to provide a unique number that is generated by a user device and a system managing the computing resource), biometric authentication (e.g., requiring a user to provide biometric data), voice authentication (e.g., requiring a user to provide verbal identification), and/or two-factor authentication (2FA) or multifactor authentication (MFA) (e.g., more than one form of authentication).

Different online interactions may require different types of authentication. For example, passively viewing a financial account may require a relatively low level of security as compared to conducting a financial transaction, which may require a relatively high degree of security. In addition, certain transactions or interactions may be subject to additional requirements, such as rules regarding financial authorization and/or other considerations to comply with regulations.

In one example, a security protocol (such as 3-D Secure) may provide security authentication with financial authorization using authentication flows that coordinate between various domains, including an acquirer domain (e.g., bank and/or merchant being paid), an issuer domain (e.g., credit/debit card issuer), and interoperability domain (e.g., infrastructure to support the protocol). The protocol may allow for different authentication flows (e.g., different processes for completing authentication requirements with authentication factors, and a lower security authentication flow corresponding to fewer authentication factors used and a higher security authentication flow corresponding to greater authentication factors used). A merchant incorporating such a security protocol often statically selects authentication flows.

However, certain authentication flows may hinder a user experience such that the user may not complete the authentication flow and instead abandon the transaction. Thus, the merchant's static selections of authentication flows may result in reduced transaction completions. Although a dynamic and/or customized authentication flow may be desirable, coordinating various servers to adhere to security protocols may prevent such dynamic/customized authentication flows.

The present disclosure is generally directed to adaptive security authentication. As will be explained in greater detail below, embodiments of the present disclosure may use one or more artificial intelligence (AI) to predict a risk score (e.g., representing a likelihood of an online transaction being fraudulent or otherwise requiring reversal) and a conversion score (e.g., representing a likelihood of an online transaction being completed rather than abandoned before completion) using transaction data of a pending online transaction. As referred to herein AI generally refer to machines (e.g., software and/or hardware) developed to think and/or act like humans. Further, although the examples herein relate to ML models (e.g., programs and/or systems trained from input data to output predictions or decisions, including unsupervised, supervised, and/or reinforcement learning models), the ML models referred to herein may correspond to any type of AI technology, including various types of machine learning, neural network (NN) (e.g., having a structure of input layers, one or more hidden layers, and an output layer, each layer performing calculations with input from a previous layer using trained/learned weights), deep learning (DL) (e.g., NN with more than three hidden layers), generative AI (GenAI) (e.g., AI trained to generate content such as text, images, video, audio, etc. as learned from existing content), large language model (LLM) (a GenAI for natural language processing to generate human-like text), etc. (e.g., any other AI model). The pending online transaction may require a security authentication, such as with a security protocol as described above, and the one or more ML models may facilitate dynamic selection of a security authentication flow based on the risk score and the conversion score. Accordingly, the systems and methods provided herein allow real-time dynamic evaluation of a pending online transaction to allow dynamic initiation of an appropriate authentication flow in real-time within a normal process flow of the online transaction. The systems and methods provided herein may advantageously improve the functioning of a computer itself by performing real-time analysis and facilitating more efficient communication between servers of the various domains involved with security authentication. The systems and methods provided herein may further improve the technical field of authentication by providing dynamic analysis of authentication factors.

Features from any of the embodiments described herein may be used in combination with one another in accordance with the general principles described herein. These and other embodiments, features, and advantages will be more fully understood upon reading the following detailed description in conjunction with the accompanying drawings and claims.

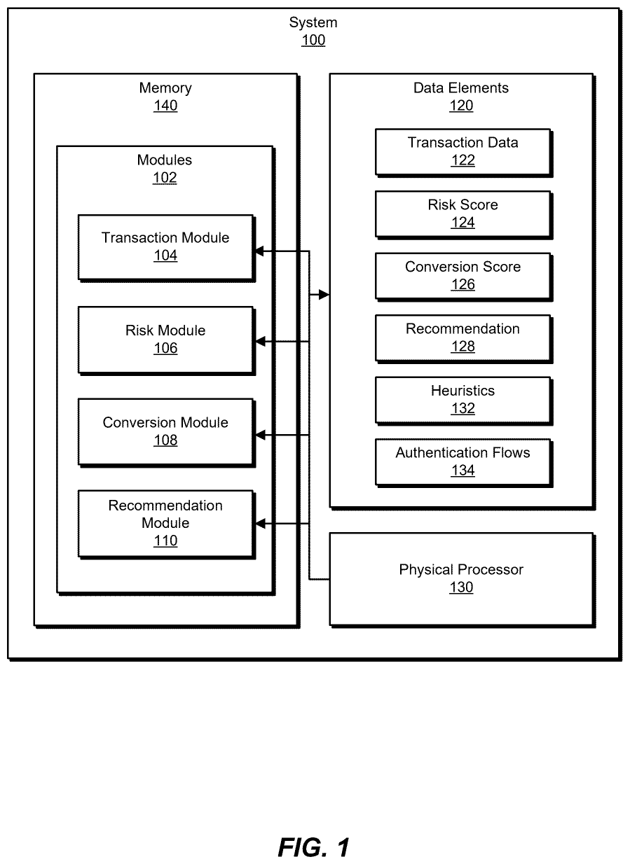

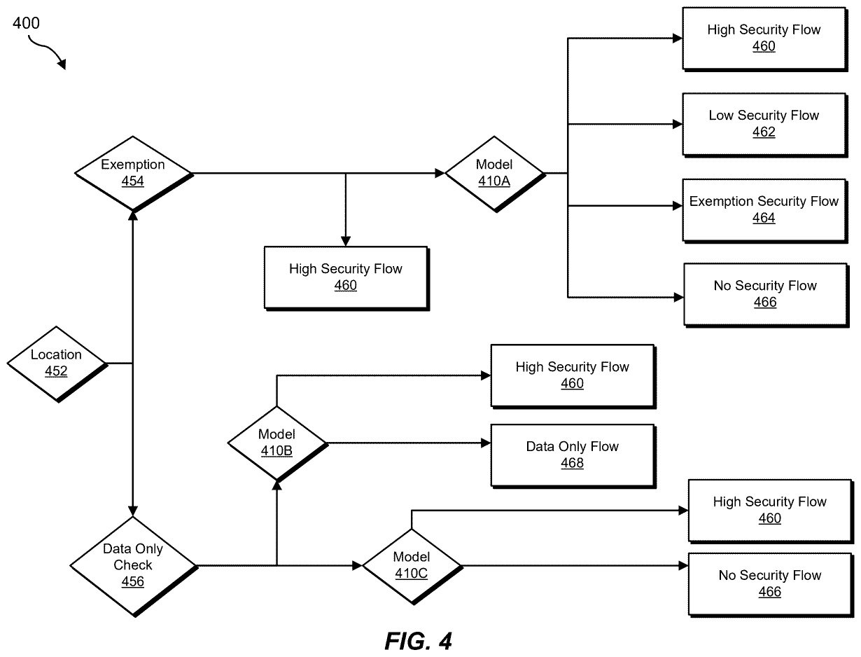

The following will provide, with reference to FIGS. 1-7, detailed descriptions of adaptive security authentication. Detailed descriptions of example systems will be provided in connection with FIGS. 1, 2, and 3. Detailed descriptions of example processes and methods will be provided in connection with FIGS. 4, 5A-5C, 6A-6B, and 7.

Various systems described herein may perform the processes described herein. FIG. 1 is a block diagram of an example system 100 for adaptive security authentication. As illustrated in this figure, example system 100 may include one or more modules 102 for performing one or more tasks. As will be explained in greater detail herein, modules 102 may include a transaction module 104 (e.g., configured to evaluate/process transaction details), a risk module 106 (e.g., configured to predict a risk associated with a transaction), a conversion module 108 (e.g., configured to predict whether a transaction will be completed), and a recommendation module 110 (e.g., configured to recommend a security authentication process for a transaction). One or more of modules 102 may be implemented with one or more machine learning models. For example, risk module 106 may be an ML model configured to predict whether a transaction is fraudulent based on transaction data. Conversion module 108 may be an ML model configured to predict whether a transaction will be completed based on transaction data. Recommendation module 110 may be an ML model configured to predict recommendation scores for one or more authentication flows, based on risk scores and conversion scores. Moreover, although illustrated as separate elements, one or more of modules 102 in FIG. 1 may represent portions of a single module, application, or model.

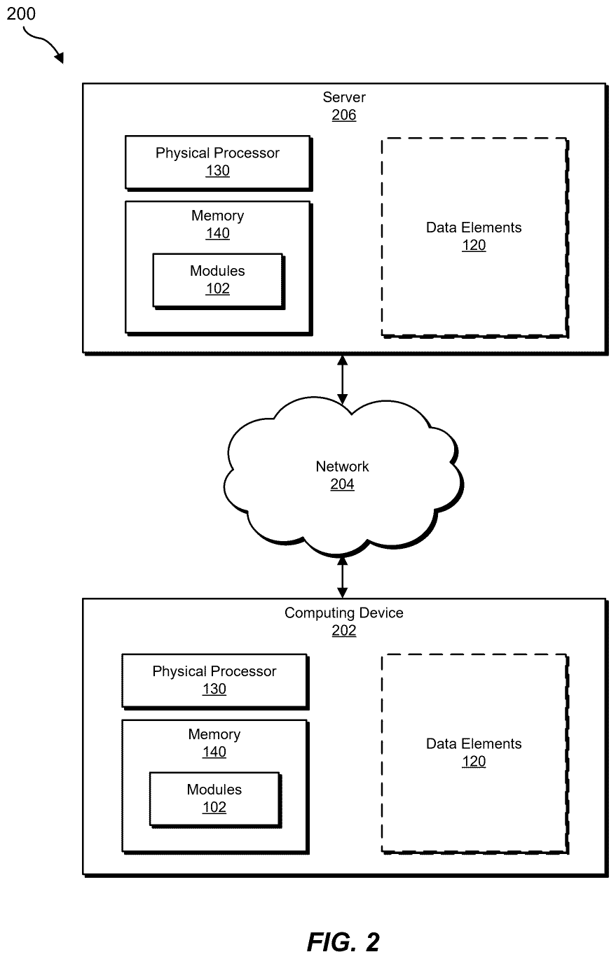

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate adaptive security authentication. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 1, example system 100 may also include one or more data elements 120, such as transaction data 122, risk score 124, conversion score 126, recommendation 128, heuristics 132, and authentication flows 134. One or more of data elements 120 may be stored on a local storage device, such as memory 140, or may be accessed remotely. Transaction data 122 may represent data corresponding to information about transactions, such as party information (e.g., user/customer and/or merchant), location (e.g., transaction location, user location, merchant location, shipping information, etc.), transaction amount (e.g., price), product/service information (e.g., identifiers, categories, etc.), merchant preferences (e.g., security preferences, risk tolerances, etc.), as will be explained further below. Risk score 124 may represent a prediction (e.g., as a value, confidence score, etc.) for whether a given transaction may be fraudulent or otherwise result in a faulty/failed transaction (e.g., requiring a reversal), as will be explained further below. Conversion score 126 may represent a prediction (e.g., as a value, confidence score, etc.) for whether a given transaction will be completed (e.g., by the user/customer) or abandoned/dropped before completion, as will be explained further below. Recommendation 128 may represent a recommendation (e.g., as a value, confidence score, and/or selection, etc.) of a particular authentication process/flow, as will be explained further below. Heuristics 132 may represent rules (e.g., based on regulations, requirements, etc.) and/or other heuristics, as will be explained further below. Authentication flows 134 may represent authentication processes (e.g., as an enumerated list of predetermined authentication flow, combinations of one or more authentication factors that may be predetermined and/or dynamically selected, etc.), as will be explained further below.

Example system 100 in FIG. 1 may be implemented in a variety of ways. For example, all or a portion of example system 100 may represent portions of example network environment 200 in FIG. 2.

FIG. 2 illustrates an example network environment 200 implementing aspects of the present disclosure. The network environment 200 includes computing device 202, a network 204, and server 206. Computing device 202 may be a client device or user device, such as a desktop computer, laptop computer, tablet device, smartphone, or other computing device. Computing device 202 may include a physical processor 130, which may be one or more processors, memory 140, which may store data and/or access such as one or more of data elements 120.

Server 206 may represent or include one or more servers capable of hosting a recommendation engine as described herein. Server 206 may provide a recommended authentication flow and in some implementations enact the recommended authentication flow, based on signals from computing device 202 and/or other servers (e.g., other instances of server 206, other types of severs such as web servers for merchant websites, data servers, etc.). Server 206 may include a physical processor 130, which may include one or more processors, memory 140, which may store modules 102, and store and/or access one or more of data elements 120.

Computing device 202 may be communicatively coupled to server 206 through network 204. Network 204 may represent any type or form of communication network, such as the Internet, and may comprise one or more physical connections, such as LAN, and/or wireless connections, such as WAN, Wi-Fi, cellular, and/or short-range wireless connections.

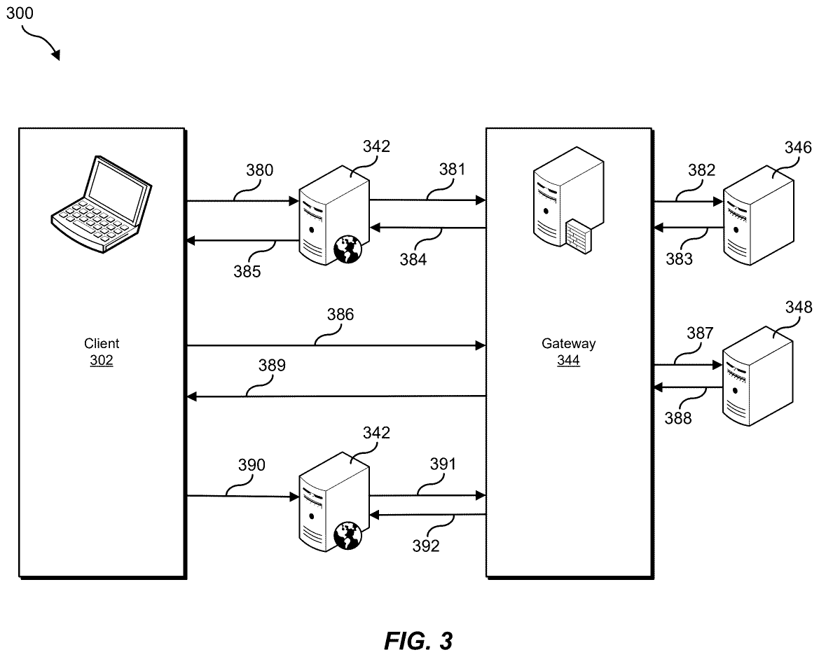

FIG. 3 illustrates a system 300 (corresponding to system 100 and/or network environment 200) of an example architecture for adaptive security authentication. FIG. 3 illustrates a client 302 (corresponding to an instance of computing device 202), a merchant server 342 (corresponding to an instance of server 206 configured for hosting a merchant website/application), a gateway 344 (corresponding to an instance of server 206 configured for interfacing between servers of various domains), a recommendation engine 346 (corresponding to an instance of server 206 configured to host ML models or other recommendation engines), and an authentication server 348 (corresponding to an instance of server 206 configured to provide authentication services such as through authentication flows).

A user, using client 302, may access a merchant's website/application as hosted on merchant server 342. Once the user initiates a checkout 380 to complete an online transaction (e.g., purchasing a product from the merchant), merchant server 342 may proceed with transaction data (e.g., user info, payment info, product info, price, shipping info, etc. that may be indicated in checkout 380) to initiate the security authentication steps needed for the online transaction, which may include authorizing the user with the appropriate financial institution, as represented by authentication server 348. In one example, in response to checkout 380, merchant server 342 may return an authentication requirement 385 indicating a requirement for one or more authentication factors to complete the transaction, which may be statically configured on merchant server 342 (e.g., using a default/general authentication flow which in some examples may be switched to a lower security authentication flow based on the presence of simple factors such as a transaction value below a threshold transaction value).

For instance, the user may be presented, via client 302, an interface for providing the one or more authentication factors, such as a prompt for inputting a password, code, and/or other requested information. To comply with authentication requirement 385, the user, using client 302, may respond with an authentication request 386 (e.g., providing the one or more authentication factors) to gateway 344. In some implementations, authentication request 386 may indicate a particular authentication flow (e.g., by explicit indication and/or passively by way of the information provided) as may be indicated by authentication requirement 385.

Gateway 344 may provide an authentication information 387 (e.g., processing and/or forwarding the one or more authentication factors provided from authentication request 386) to authentication server 348. In some examples, authentication information 387 may explicitly and/or passively indicate the authentication flow. Authentication server 348 may then authenticate the user based on the information provided via authentication request 386 and/or authentication information 387. Authentication may include, for example, confirming or otherwise validating any requested information (e.g., for the one or more authentication factors of the authentication flow), which in some examples may include validating the user, validating the user's financial account, etc.

Once authenticated, authentication server 348 may provide an authentication confirmation 388 to gateway 344. Gateway 344 may provide an authentication completion 389 to client 302 (e.g., processing and/or forwarding authentication confirmation 388), indicating a successful authentication. Client 302 may then provide an authentication success 390 to merchant server 342, which may proceed with the transaction by providing a transaction request 391 to gateway 344. In some examples, gateway 344 may also track authentication confirmation 388, for instance to match with transaction request 391. Gateway 344 may process the transaction (e.g., completing the transfer of funds as indicated in transaction request 391 and further corresponding to checkout 380) and provide a transaction completion 392 to merchant server 342.

However, as described above, merchant server 342 may be statically configured with a default authentication flow, with limited ability to adjust the authentication flow on a per-transaction, real-time basis. As described herein, authentication flows may provide friction to the user experience, such as providing interfaces and/or requiring authentication factors that may not be correctly supported by client 302, providing extra steps that the user may not complete, arousing suspicion by the user from the request for extra information, failed/dropped messages required for the authentication flow, etc. As described herein, an adaptive security authorization allows for a dynamically selected and/or tuned authentication flow that may be determined in real-time on a per-transaction basis, to provide an authentication flow that may be compatible with the devices and servers involved, better coordinates communication therebetween, satisfies any regulatory requirements, and balances transaction risk against conversion.

In some implementations, after checkout 380, merchant server 342, rather than responding with authentication requirement 385, may first coordinate with recommendation engine 346. For example, merchant server 342 may send an adaptive authentication request 381, that may include transaction details (e.g., as may be provided from checkout 380), to gateway 344. Gateway 344 may then provide a forwarded adaptive authentication request 382 to recommendation engine 346 (e.g., processing and/or forwarding adaptive authentication request 381). Recommendation engine 346 may provide a recommendation 383 (e.g., selecting an authentication flow and/or otherwise selecting one or more particular authentication factors), determined based on the information (e.g., geolocation, merchant transaction history, issuer transaction history, etc.) as will be described in further detail below, to gateway 344. Gateway 344 may then provide a forwarded recommendation 384 to merchant server 342 (e.g., processing and/or forwarding recommendation 383). Based on recommendation 383, merchant server 342 may accordingly provide authentication requirement 385 to client 302, for completion as described above (e.g., continuing with authentication request 386).

Further, FIG. 3 illustrates an example of a successful authentication (e.g., a flow if no failures/errors encountered). However, in other examples, the authentication may fail for one or more reasons, such as failing to provide the correct authentication factor (e.g., providing incorrect and/or false information whether by mistake or intentionally), errors with the transaction flow (e.g., dropped communications, aborting the transaction, etc.). In examples of failed authentication, success messages (e.g., authentication confirmation 388, authentication completion 389, and/or authentication success 390) may not be sent, the transaction not completed (e.g., transaction request 391 and/or transaction completion 392 not being sent) and/or any other message sequence may not be completed. For instance, failure messages may be sent instead of success messages, and/or the transaction process dropped (e.g., due to insufficient funds and/or other errors).

Turning now to FIG. 4, FIG. 4 illustrates a flowchart of a process 400 representing an example process for determining a recommendation (e.g., as may be used by recommendation engine 346 to generate recommendation 383). FIG. 4 may correspond to a particular security protocol, although in other examples may be accordingly adapted for other security protocols. In particular, the authentication flows described herein and/or threshold determinations may be adapted for other security protocols.

In some examples, process 400 may begin performing an analysis of an online transaction being initiated at a location 452, using transaction data from the online transaction (e.g., transaction data 122 and/or portions thereof) and based on rules/heuristics (e.g., heuristics 132). In some examples, regulations that may establish security/authentication requirements may be location-based. For example, certain locations (e.g., countries, regions, etc.) may have regulations that may be different from those of other locations. Accordingly, an initial heuristic may include the determination of location 452, which may include identifying locations of the parties to the transaction (e.g., the user/buyer/acquirer, the merchant/issuer, etc.) using the transaction data.

In FIG. 4, the analysis of location 452 may include a determination of whether both a country of the issuer and a country of the acquirer are in a same regulatory region (e.g., PSD2) to continue to an exemption 454 analysis and otherwise proceed to a data only check 456 analysis, as will be described further below. At exemption 454, whether a valid exemption is available for this transaction may be determined based on heuristics (e.g., based on heuristics 132). For example, the location corresponding to location 452 (e.g., PSD2) may allow for a reduced security authentication flow based on an exemption. In some examples, the exemption may correspond to the transaction value being below a threshold value (e.g., $250 or other threshold as may be defined in regulations). In other examples, other exemption conditions may apply, such as number of exemptions consecutively applied (e.g., for the issuer) passing a threshold number of exemptions (e.g., less than 5 exemptions in a row), transaction value amounts in prior exemptions (e.g., less than 100 Euros in past exemptions), type of transaction, identity of issuer and/or acquirer, location of issuer and/or acquirer, etc.

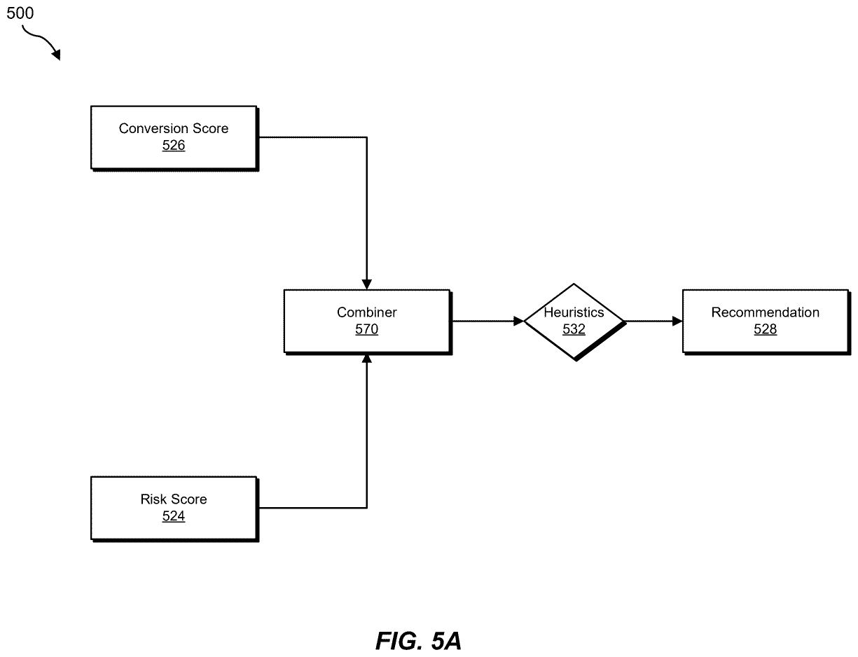

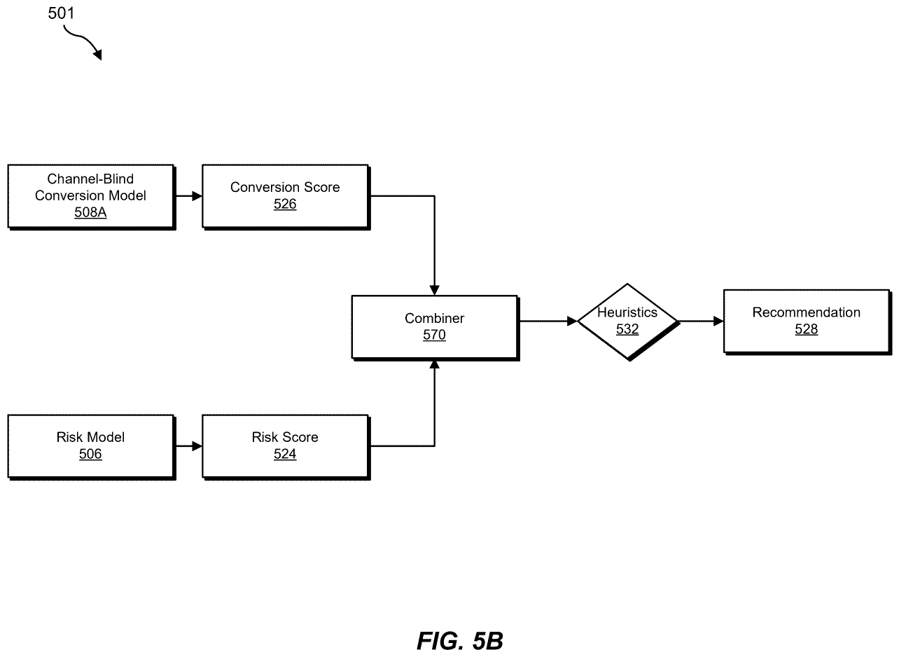

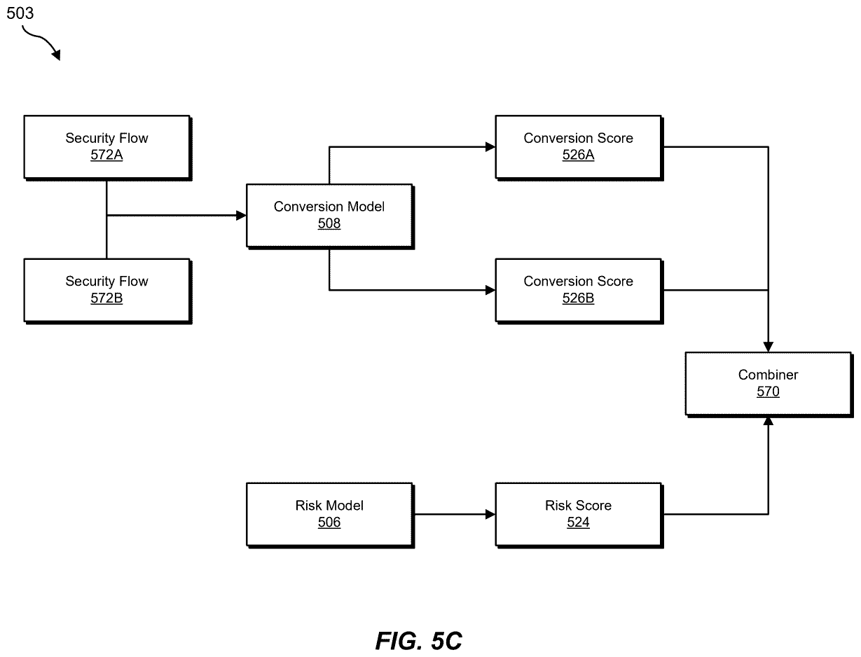

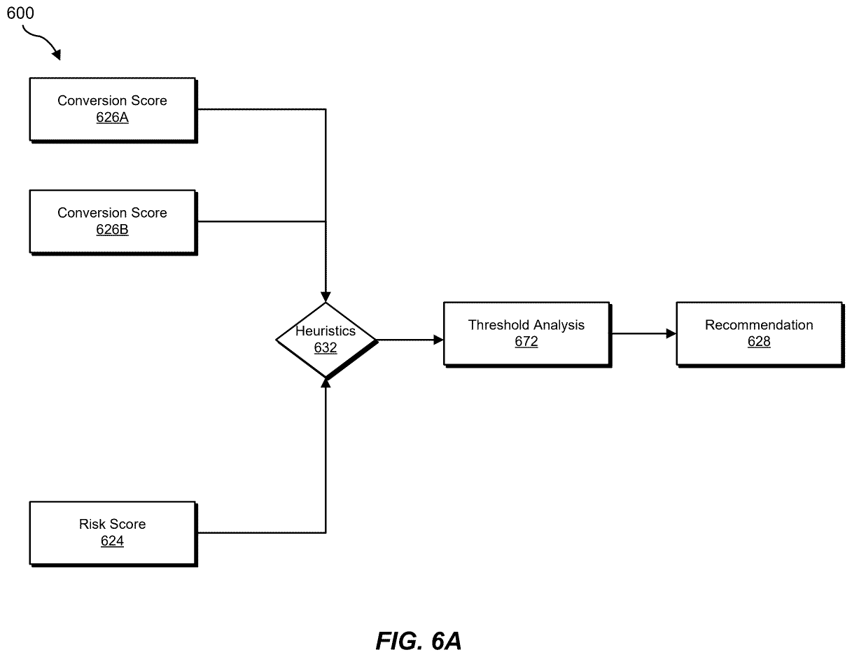

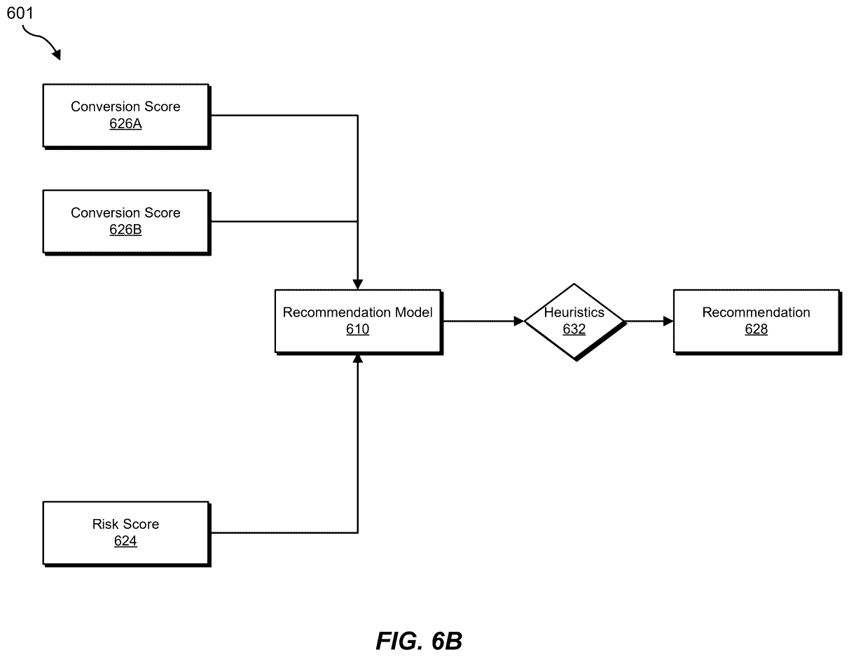

If the exemption applies at exemption 454, a reduced or lower security authentication flow may be available. In other words, a less restrictive authentication flow may still satisfy any regulatory requirements for the transaction. However, rather than relying on a regulatory minimum requirement that is otherwise detached from the specific transaction, process 400 may include additional analysis of the transaction to determine a more appropriate authentication flow. A model 410A (corresponding to an instance of recommendation module 110) may analyze the transaction data. As will be explained further below (e.g., with respect to FIGS. 5A-5C and 6A-6B), model 410A may analyze the transaction (e.g., balancing risk with conversion) to determine a recommendation for an authentication flow. In FIG. 4, model 410A may be able to select from all available authentication flows or otherwise a least restricted set of authentication flows. In other words, based on location 452 and exemption 454, model 410A may have more leeway to select from lower security authentication flows (e.g., as minimally required based on location 452 and/or exemption 454), as well as higher security authentication flows.

FIG. 4 further illustrates various example authentication flows (e.g., examples of authentication flows 134) including a high security flow 460, a low security flow 462, an exemption security flow 464, and a no security flow 466. High security flow 460 may correspond to an authentication flow that may be higher security (e.g., requiring multiple authentication factors, requiring validation of identity and/or account without relying on a previous authentication, etc.) and in some implementations may correspond to a highest security authentication flow. Low security flow 462 may correspond to a lower security (e.g., requiring less authentication factors than high security flow 460). Exemption security flow 464 may correspond to a lower security (e.g., requiring less authentication factors than high security flow 460) and in some implementations may correspond to a particular set of authentication factors allowed for the exemption and in other implementations may correspond to skipping authentication factors. No security flow 466 may correspond to a lower security (e.g., requiring less authentication factors than high security flow 460) and in some implementations may correspond to no authentication factors (e.g., skipping authentication factors).

Although the authentication flows described herein may correspond to predefined flows (e.g., predetermined set of authentication factors), in other examples, the authentication flows described herein may correspond to dynamically defined authentication flows, such as selecting a combination of authentication factors as appropriate for a recommended security level (correlating to risk) and/or conversion. Moreover, although different security flows may be labelled as different, in some examples, authentication flows of similar security levels may correspond to a similar set of authentication factors. Moreover, in some examples, additional or fewer flows may be used, as desired. For instance, there may be multiple levels of high security flows.

### Based on the Transaction, Model 410a May Recommend One of

the authentication flows, which may then be initiated to complete the transaction. If exemption 454 does not apply, (e.g., the transaction amount surpassing the threshold exemption amount, a number of exemptions consecutively applied exceeding the threshold number of exemptions, etc.), then high security flow 460 may be recommended (e.g., may be required if exemption 454 does not apply).

Further, if at location 452, if the parties (e.g., issuer and acquirer) are not in a location having specific regulations (e.g., not in PSD2), a data only check 456 determination may be made based on heuristics 132. In some examples, certain issuers may allow for a data only flow, in which data on the transaction may be used without requiring additional authentication (e.g., one or more authentication factors). Although FIG. 4 illustrates data only check 456, in other implementations, other types of rules/heuristics may be applied. Based on the transaction data, if the data only flow is available (e.g., the issuer supports data only), then a model 410B (corresponding to an instance of recommendation module 110) may determine an appropriate authentication flow (e.g., that may balance risk with conversion as will be described further below). For example, even if a data only flow 468 (corresponding to an example of authentication flows 134) is available, model 410B may recommend high security flow 460. In other examples, model 410B may recommend data only flow 468.

If data only check 456 is not available (e.g., the issuer does not support the data only flow), then a model 410C (corresponding to an instance of recommendation module 110) may recommend an authentication flow based on the transaction data. In some example, model 410C may be limited in which authentication flows to select from (e.g., being more limited than 410A and/or model 410B in a number of authentication flows and/or types of authentication flows), such as selecting a recommendation between high security flow 460 and no security flow 466. Based on the recommended authentication flow, the transaction may continue.

The models and/or recommendation engines described herein (e.g., model 410A, model 410B, model 410C, etc.) may provide recommendations based on various factors, as will be discussed in reference to FIGS. 5A-5C and 6A-6B. FIG. 5A illustrates a process 500 of an example flowchart for a recommendation of a security authentication flow for an online transaction. Process 500 may begin with determining a conversion score 526 (corresponding to an instance of conversion score 126) and a risk score 524 (corresponding to an instance of risk score 124). Conversion score 526 may be a value (e.g., between 0 and 1, a percent, etc.) representing a prediction of transaction success (e.g., completing the transaction) for the transaction, and may correspond to a channel-blind conversion prediction (e.g., not accounting for differences in authentication flows or otherwise considering all authentication flows) or a per-channel conversion prediction (e.g., having separate conversion predictions for each authentication flow), as will be described further below with respect to FIGS. 5B-5C. In addition, although the examples herein describe conversion score 526 with respect to a probability of transaction success/completion, in other examples conversion score 526 may represent a probability of transaction abandonment. Risk score 524 may be a value (e.g., between 0 and 1, a percent, etc.) representing a prediction of transaction failure such as a chargeback (e.g., requiring the issuer to reverse a money transfer which in some examples may be subject to consumer protection regulations to reverse unauthorized transfers due to fraud). In addition, although the examples herein describe risk score 524 with respect to a probability of chargeback, in other examples, risk score 524 may represent a probability of no chargeback. As will be described further below with respect to FIGS. 5B-5C, risk score 524 may be based on binary classification.

A combiner 570 (corresponding to an instance of recommendation module 110 and/or a recommendation engine such as recommendation engine 346) may combine or otherwise use both conversion score 526 and risk score 524 to weigh the risk of chargeback against a conversion (e.g., to consider how a higher security authentication flow in view of potential risk may adversely impact conversion). In some examples, the combining of conversion score 526 and risk score 524 may be based on rules (e.g., applying one or more thresholds), learnable weights in a neural network or other ML model, etc., as will be described further below with respect to FIGS. 6A-6B.

The recommendation engine may continue by applying heuristics 532 (corresponding to heuristics 132). Heuristics 532 may represent regulations, rules, and/or other thresholds that may be statically applied, including, for example, location-based heuristics (e.g., location 452 in FIG. 4), transaction types and applicable exemptions (e.g., exemption 454), whether the issuer allows certain reduced security authentication flows (e.g., data only check 456), etc. In some examples, heuristics 532 may be used to eliminate certain authentication flows from being recommended (e.g., if the corresponding thresholds are not met), which may include removing the eliminated options from being selected, zeroing out the corresponding recommendation and/or conversion score, etc. In other examples, heuristics 532 may be used to include certain authentication flows (e.g., if the corresponding thresholds are met). Further, in some implementations, heuristics 532 may be used to filter out certain authentication flows from being considered, such that the recommendation engine may apply one or more of heuristics 532 before predicting conversion score 526 and/or risk score 524 (see, for example FIG. 4). Moreover, in some examples, heuristics 532 may incorporate authentication preferences of any of the involved parties (e.g., issuer, acquirer, etc.) that may be used for selecting/elimination authentication flows.

After combining conversion score 526 and risk score 524 and applying heuristics 532, the recommendation engine may provide a recommendation 528 (corresponding to an instance of recommendation 128) of an authentication flow, which may then be initiated to continue processing the transaction. The recommended authentication flow may be a one of multiple authentication flow options (e.g., high security flow 460, low security flow 462, exemption security flow 464, no security flow 466, data only flow 468, etc.) or may be a dynamically generated authentication flow including one or more authentication factors that may be selected by the recommendation engine based on weighing conversion score 526 against risk score 524 and complying with any relevant regulations (e.g., represented by heuristics 532).

FIG. 5B illustrates a process 501 that may be a variation of process 500 in FIG. 5A, and in some examples corresponds to a channel-blind conversion prediction (e.g., a channel referring to a possible authentication flow). A channel-blind conversion model 508A (corresponding to an instance of conversion module 108) may generate conversion score 526 that may represent a general conversion prediction for the transaction. Channel-blind conversion model 508A may be an ML model trained to take transaction data (e.g., acquirer information such as location/demographics/purchase history, issuer information such as location/transaction history, transaction amount, type of transaction, goods/services being purchased, etc.) and outputs a score or embedding representation of a transaction's likelihood to successfully convert, as conversion score 526. For example, the training data for channel-blind conversion model 508A may include historical transaction data that may indicate pending transactions and whether the pending transactions were completed. Because the authentication flow may affect the conversion rate (e.g., a higher security authentication flow or a greater number of authentication factors may hinder a user from completing the transaction and a lower security authentication flow or a lesser number of authentication factors may facilitate the user completing the transaction), the channel-blind analysis may perform prediction assuming one of: no authentication flow, a lowest security authentication flow, a highest security authentication flow, a default authentication flow, or a combination of all authentication flows. In other words, channel-blind conversion model 508A may not consider the type of authentication flow as an input for prediction (and in some examples, the training data for channel-blind conversion model 508A may not reflect authentication flows used).

A risk model 506 (corresponding to an instance of risk module 106) may generate risk score 524. Risk model 506 may be an ML model trained to take transaction data and output a score or embedding representation of a transaction's likelihood to result in a chargeback, as risk score 524. For example, the training data for risk model 506 may include historical transaction data that may indicate transactions and which transactions resulted in chargeback. In some examples, risk model 506 may be a separate ML model than channel-blind conversion model 508A, although in other examples may be combined (e.g., a same model).

Combiner 570 may combine conversion score 526 and risk score 524 as described herein. Combiner 570 may be an ML model that may take the outputs of channel-blind conversion model 508A (e.g., conversion score 526) and risk model 506 (e.g., risk score 524), and outputs a score for a transaction's likelihood to convert for various authentication flows. In some examples, combiner 570 may be a separate model from channel-blind conversion model 508A and risk model 506, although in other examples may be combined with channel-blind conversion model 508A and/or risk model 506. The recommendation engine (which may correspond to one or more of the models described herein such as channel-blind conversion model 508A, risk model 506 and/or combiner 570) may adjust the available authentication flows based on applying heuristics 532, and of the remaining available authentication flows, select as recommendation 528 the authentication flow corresponding to a highest likelihood of converting. In some examples, the recommendation engine may select an authentication flow if it satisfies a threshold conversion value. In some examples, the recommendation engine may select a default authentication flow (e.g., a highest security authentication flow) if no authentication flows were otherwise selected. Further, in some examples, after initiating the authentication flow of recommendation 528, a transaction result (e.g., completion, abandonment, chargeback, etc.) may be provided as feedback to the models described herein (e.g., channel-blind conversion model 508A, risk model 506, combiner 570, etc.) as well as used to update heuristics 532.

FIG. 5C illustrates a process 503 corresponding to a variation of process 501, such as a per-channel conversion prediction (e.g., individually analyzing each of the available authentication flows) rather than a channel-blind conversion prediction of FIG. 5B. FIG. 5C includes a conversion model 508 (corresponding to an instance of conversion module 108) which in some examples may be similar to channel-blind conversion model 508A that may take an authentication flow as an additional input, although in other examples, conversion model 508 may correspond to one or more separate models (e.g., one or more models having been trained on separate training data sets for the different authentication flows).

FIG. 5C illustrates two example inputs, a security flow 572A (corresponding to an example of authentication flows 134, such as one of high security flow 460, low security flow 462, exemption security flow 464, no security flow 466, and/or data only flow 468) and a security flow 572B (corresponding to a different example of authentication flows 134, such as another one of high security flow 460, low security flow 462, exemption security flow 464, no security flow 466, and/or data only flow 468), although in other examples, additional security flow inputs may be used. For example, the available security flow inputs may correspond to all possible authentication flows (e.g., either predetermined and/or based on possible combinations of authentication factors), or may correspond to a subset thereof, such as after applying certain heuristics.

In addition, in some implementations, security flow 572A and/or security flow 572B may include or otherwise represent transaction feature information in addition to authentication flow information/identification. For example, transaction features may correspond to transaction information relevant to a particular authentication flow, as well as features specific to each authentication flow, such as historical success of a given authentication flow, historical approval/decline rate of the given authentication flow, etc.

For each of the input security flows (e.g., security flow 572A and security flow 572B) conversion model 508 may provide a respective prediction. For example, conversion model 508 may output a conversion score 526A (corresponding to an instance of conversion score 126) for security flow 572A, and output a conversion score 526B (corresponding to another instance of conversion score 126) for security flow 572B. In some implementations, conversion score 526A and/or conversion score 526B may represent a granular (e.g., specific to the corresponding authentication flow) form of conversion score 526 in FIGS. 5A-5B. Alternatively, conversion score 526 may represent the individual conversion scores (e.g., conversion score 526A and conversion score 526B) collectively.

Similar to FIG. 5B, risk model 506 may output risk score 524. Combiner 570 may receive conversion score 526A, conversion score 526B (and/or any other individual conversion scores), and risk score 524 and combine them as described herein (e.g., as in FIGS. 5A-5B). In addition, combiner 570 may be further configured as an ML model trained to take multiple different conversion scores (with additional context such as transaction features, authentication flow features, etc.) and/or apply additional thresholding rules for analyzing the different authentication flows.

In some implementations, combiner 570 may also be configured with risk thresholding rules. For instance, combiner 570 may use a risk tolerance threshold (corresponding to an acceptable level of chargeback rates for a merchant) and/or a risk tolerance (corresponding a current level of chargebacks of a merchant) that may be provided and/or determined from the transaction data (e.g., by identifying the merchant and retrieving the corresponding risk tolerance threshold and/or risk tolerance). Combiner 570 may also use a transaction abandonment threshold (e.g., corresponding to an acceptable level of abandoned transactions or drop-offs) and a transaction abandonment rate (e.g., corresponding to an acceptable level of drop-offs), as will be described further with respect to FIGS. 6A-6B.

FIG. 6A illustrates a process 600 and FIG. 6B illustrates a process 601, each corresponding to variations of FIG. 5C. FIGS. 6A-6B include a conversion score 626A (corresponding to an instance of conversion score 126 and/or conversion score 526A), a conversion score 626B (corresponding to another instance of conversion score 126 and/or conversion score 526B), a risk score 624 (corresponding to an instance of risk score 124 and/or risk score 524), and heuristics 632 (corresponding to heuristics 132 and/or heuristics 532).

In some examples, certain higher security authentication flows may shift chargeback liability to acquirer such that the recommendation engine may use the risk tolerance threshold, risk tolerance, transaction abandonment threshold, and/or the transaction abandonment rate described herein to determine whether the chargeback liability shifting authentication flows should be used. For instance, in FIG. 6A, after adjusting the available/feasible authentication flows using heuristics 632 (e.g., as described herein), the recommendation engine may apply a threshold analysis 672 (corresponding another instance of heuristics 132 and/or heuristics 532) for outputting a recommendation 628 (corresponding to an instance of recommendation 128 and/or recommendation 528). Threshold analysis 672 may include evaluating if the risk tolerance exceeds the risk tolerance threshold (e.g., indicating that the merchant has crossed the acceptable chargeback level and/or that the merchant has crossed an acceptable number of chargebacks that have shifted liability to the acquirer), the recommendation engine may not select the higher security authentication flows. If (also at threshold analysis 672) the transaction abandonment rate exceeds the transaction abandonment threshold (e.g., indicating that the number of transactions that have been abandoned due to the higher security authentication flows has crossed an acceptable number of abandoned transactions), the recommendation engine may not select the higher security authentication flows.

Additional thresholding rules (e.g., at threshold analysis 672) may be used, such as if both the risk tolerance threshold and the transaction abandonment thresholds have not been exceeded. In such scenarios, the recommendation engine may compare the risk score (e.g., risk score 524) to a risk score threshold (e.g., corresponding to a risk level for which a higher security authentication flow is preferred). If the risk score exceeds the risk score threshold (e.g., indicating that the transaction has an unacceptably high level of risk), the recommendation engine may select a higher (e.g., highest) security authentication flow. Otherwise, the recommendation engine may select an authentication flow with a high (e.g., highest) conversion score.

In other implementations (e.g., FIG. 6B), the thresholding rules described above may be implemented with the ML model itself, such that a recommendation model 610 (corresponding to an instance of recommendation module 110 and/or combiner 570) may be trained with training data that incorporates the thresholding rules, which may include the risk tolerance and/or the transaction abandonment rate as additional inputs (e.g., based on identifying the merchant). In addition, the model may also take the thresholds (e.g., the risk tolerance threshold, transaction abandonment threshold, and/or risk threshold) as configurable parameters. The recommendation engine may apply heuristics 632, which may include rules for selecting an authentication flow (e.g., based on a highest recommendation score) to output recommendation 628. In other examples, recommendation model 610 may incorporate heuristics 632.

Moreover, the examples described herein may utilize per-channel conversion (e.g., FIG. 5C) and/or channel-blind conversion (e.g., FIG. 5B), including switching between the two based on heuristics as needed. For example, the recommendation engine may use per-channel conversion prediction for certain types of transactions (e.g., transactions having lower security requirements and therefore having more available authentication flows) and may user channel-blind conversion prediction for other types of transactions (e.g., transaction having higher security requirements and therefore having fewer available authentication flows).

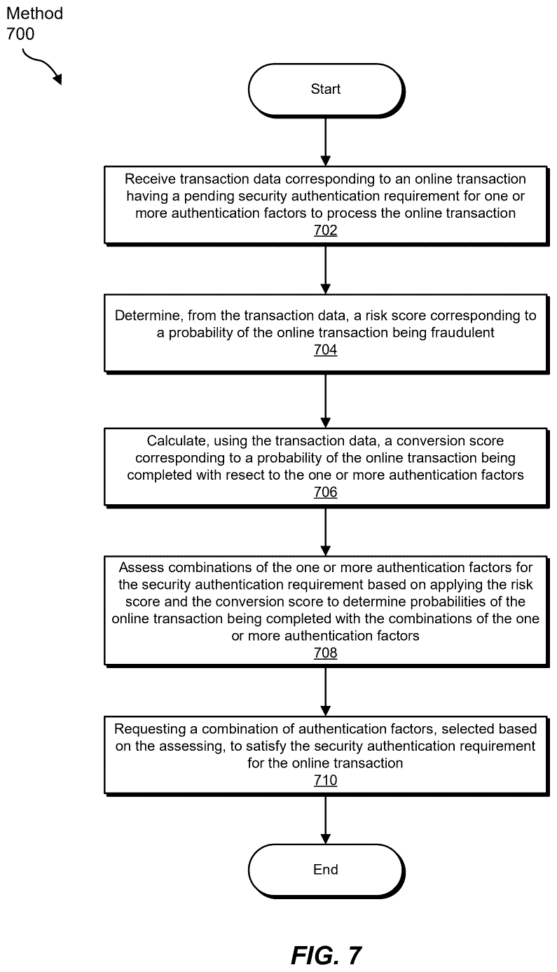

FIG. 7 is a flow diagram of an example computer-implemented method 700 for adaptive security authentication. The steps shown in FIG. 7 may be performed by any suitable computer-executable code and/or computing system, including the system(s) illustrated in FIGS. 1, 2, and/or 3. In one example, each of the steps shown in FIG. 7 may represent an algorithm whose structure includes and/or is represented by multiple sub-steps, examples of which will be provided in greater detail below.

As illustrated in FIG. 7, at step 702 one or more of the systems described herein may receive transaction data corresponding to an online transaction having a pending security authentication requirement for one or more authentication factors to process the online transaction. For example, transaction module 104 may receive transaction data 122 of an online transaction in finalizing a checkout stage of a purchase, or other final stage of transferring funds (e.g., checkout 380 in FIG. 3).

At step 704 one or more of the systems described herein may determine, from the transaction data, a risk score corresponding to a probability of the online transaction being fraudulent. For example, risk module 106 may calculate risk score 124 using transaction data 122.

The systems described herein may perform step 704 in a variety of ways. In one example, determining the risk score is based on a machine learning model configured to detect fraudulent transaction probabilities (e.g., risk model 506). In some examples, the machine learning model is configured to output the risk score based on chargeback fraud binary classification.

At step 706 one or more of the systems described herein may calculate, using the transaction data, a conversion score corresponding to a probability of the online transaction being completed with respect to the one or more authentication factors. For example, conversion module 108 may calculate conversion score 126 using transaction data 122.

The systems described herein may perform step 706 in a variety of ways. In one example, calculating the conversion score is based on a machine learning model (e.g., conversion model 508, channel-blind conversion model 508A) configured to determine transaction completion probabilities. In some examples, the machine learning model is configured to output a global conversion score for the one or more authentication factors (e.g., channel-blind conversion model 508A).

In some examples, the machine learning model is configured to output a local conversion score for each of a plurality of security authentication flows that use the one or more authentication factors (e.g., conversion model 508). In some examples, conversion module 108 and/or transaction module 104 may transform transaction data 122 for each of the plurality of security authentication flows (e.g., for each of authentication flows 134) to calculate the local conversion score for each of the plurality of security authentication flows.

At step 708 one or more of the systems described herein may assess combinations of the one or more authentication factors for the security authentication requirement based on applying the risk score and the conversion score to determine probabilities of the online transaction being completed with the combinations of the one or more authentication factors. For example, recommendation module 110 may assess authentication flows 134 using risk score 124 and conversion score 126.

The systems described herein may perform step 708 in a variety of ways. In one example, performing the determining the risk score, the calculating the conversion score, and the assessing the combinations of authentication factors using a machine learning model configured to select the combination of authentication factors from the transaction data (e.g., risk module 106, conversion module 108, and recommendation module 110, which in some implementations may correspond to the same ML model).

At step 710 one or more of the systems described herein may request a combination of authentication factors, selected based on the assessing, to satisfy the security authentication requirement for the online transaction. For example, recommendation module 110 may output recommendation 128 comprising a combination of authentication factors (as assessed and selected at step 710). Recommendation module 110 and/or transaction module 104 may then initiate the selected combination of authentication factors to satisfy the security authentication requirement of the online transaction.

The systems described herein may perform step 710 in a variety of ways. In one example, selecting from the one or more authentication factors further comprises selecting, when the risk score exceeds a risk score threshold, a combination of authentication factors associated with a higher security than another combination of authentication factors. In some examples, certain authentication factors may be considered higher security (e.g., passphrase being higher security than password or PIN, etc.) and a greater number of authentication factors may be considered higher security (e.g., 2FA, MFA, Etc.).

In some examples, selecting the combination of authentication factors is further based on selecting, when the risk score is below a risk score threshold, a combination of authentication factors having a higher conversion score than another combination of authentication factors. For instance, lower security/fewer authentication factors may be associated with higher conversion.

In some examples, selecting the combination of authentication factors is further based on applying one or more heuristics that are independent from the risk score and the conversion score to filter out one or more combinations of the one or more authentication factors from being selected. Exemptions, regulatory requirements, etc. as described herein may further be used. For example, the one or more heuristics may include filtering out combinations of the one or more authentication factors based on location data associated with the online transaction.

In some examples, the one or more heuristics includes filtering out combinations of the one or more authentication factors based on a risk tolerance threshold corresponding to an acceptable level of chargeback rates or a transaction abandonment threshold corresponding to an acceptable level of abandoned transactions. For example, as discussed above with respect to FIGS. 6A-6B, shifting liability may require certain combinations of authentication factors. When the transaction is appropriate for shifting liability (e.g., based on the threshold analysis), the related authentication factors may be selected, such as acquirer-based authentication factors.

As detailed above, in the domain of digital financial transactions, ensuring the security and integrity of online payments remains a challenge for merchants. Security protocols, such as the 3D Secure authentication protocol, provide a layer of security to mitigate fraud risks. However, these mechanisms are often heavily dependent on predefined rules for identifying and routing transactions for authentication. Additionally, the static and manual nature of rule-based processes is ill-suited to adapt to the rapidly evolving patterns of fraudulent activities, rendering them either overly restrictive, leading to an increased rate of false declines and a subsequent negative impact on customer experience, or insufficiently stringent, thereby exposing merchants to heightened fraud risks. The existing systems lack the necessary dynamism and intelligence to effectively balance fraud prevention with operational efficiency and user experience optimization.

The present disclosure provides a solution in the form of an Artificial Intelligence (AI)-backed Rules Manager that may be integrated with 3D Secure protocol or other security protocol. Leveraging machine learning algorithms and real-time transaction data analysis allows dynamic adjusting and/or optimizing 3D Secure rules for fraud detection. By automating the rule creation and adjustment process, the systems and methods described herein may enhances the ability to counteract fraudulent transactions in real-time, while simultaneously reducing false positives and improving the transaction experience for legitimate users.

The systems and methods described herein may incorporate an AI model that utilizes machine learning algorithms to continuously analyze transaction data and evolving fraud patterns. This model may automatically adjust the 3D Secure rules, thereby improving the accuracy and effectiveness of fraud detection over time. The AI model may understand a payment based on characteristics such as origination, value, origination regulatory requirements, issuer level acceptance of the payment, and more, and may subsequently determine a feasible payments authentication routing.

The systems and methods described herein further provide customizable AI models that merchants may tailor to their specific operational contexts and risk profiles. This customization capability ensures that the fraud detection system may align with the unique business requirements and fraud exposure levels of different merchants.

A real-time data analysis component is integrated within the transaction processing workflow, enabling the system to make immediate and informed decisions based on the latest available data, thus ensuring timely detection and mitigation of fraud risks. In addition, the system may employ advanced algorithms designed to minimize false positives, ensuring that legitimate transactions are processed with reduced friction, thereby enhancing the overall customer experience and satisfaction.

Through the dynamic adjustment of 3D Secure rules based on real-time data analysis and evolving fraud patterns, the present disclosure provides improved fraud detection capabilities. By automating the rule-setting process, the present disclosure reduces the need for manual intervention, thus saving time and resources. The system's ability to accurately distinguish between fraudulent and legitimate transactions may reduce unnecessary declines, enhancing the checkout process for users. The inclusion of an analytics module may provide merchants with valuable insights for strategic decision-making and operational improvements.

The systems and methods described herein provide an advancement in the field of online transaction security, providing an intelligent, efficient, and adaptable solution to the challenges of fraud detection and prevention in digital payments. Utilizing advanced AI and machine learning algorithms, the systems provided herein may analyze each transaction's origin, value, merchant category, customer behavior, and other relevant data. Based on this analysis, the system may determine the optimal authentication path. For example, if a transaction originates from a bank known for high rates of frictionless approvals in the 3D Secure framework, the recommendation engine is more likely to route the transaction through 3DS, anticipating a smooth and secure approval process without additional friction for the customer.

A first example transaction may correspond to a medium-value online retail purchase in the EU, having a transaction value of €600, and a country of origination being Netherlands (under PSD2). The context of the transaction may be a consumer purchasing a high-end kitchen appliance from an online retailer. Given the transaction's medium value and PSD2 regulation, the system routes it through 3D Secure 2.0 to comply with Strong Customer Authentication (SCA) requirements. The transaction's risk is assessed in real-time, and because the merchant's bank supports frictionless flow, the purchase is likely authenticated without additional steps for the customer, provided the risk analysis deems it low risk.

A second example transaction may correspond to a low-value subscription renewal in the EU, having a transaction value of €15, and a country of origination being Ireland (under PSD2). The context of the transaction may be a user renewing a monthly subscription for a cloud storage service. Considering the low value and the recurring nature of the transaction, the system may apply a low-risk exemption under PSD2, bypassing SCA to facilitate a smooth, frictionless transaction. This may improve the user experience by eliminating unnecessary authentication steps for trusted, recurring transactions.

A third example may correspond to a high-value electronics purchase in the US, having a transaction value of $2,200, and a country of origination of United States. The context may be a customer buying a high-end television and sound system from an online electronics store. Due to the high transaction value and the absence of PSD2-like regulations, the decision to apply 3D Secure may depend on the merchant's risk tolerance and the customer's purchasing history. The system may route this transaction through 3D Secure for added security, given the high value, but also consider the issuer's and acquirer's fraud prevention capabilities and the likelihood of a chargeback.

A fourth example may correspond to a micro-transaction for digital content in Africa, having a transaction value of ZAR 50 (approximately $3 USD) and a country of origination of South Africa. The context may be a user purchasing a digital book from an online marketplace. Considering the low value of the transaction and potentially higher rates of fraud in certain regions, the system may evaluate the risk based on local fraud trends and the merchant's preferences. For such low-value transactions, it might leverage “3D Secure data-only” to authenticate the transaction with minimal friction, especially if the historical data suggests a low risk of fraud for similar transactions.

In some aspects, the techniques described herein relate to a system including: a processor; and a non-transitory computer-readable medium having stored thereon instructions that are executable by the processor to cause the system to perform operations including: detecting a pending security authentication requirement for an online transaction; predicting, with a first machine learning model using transaction data associated with the online transaction, a risk score of the online transaction being fraudulent; predicting, with a second machine learning model using the transaction data, a conversion score of the online transaction being completed with each of a plurality of security authentication flows; predicting, with a third machine learning model configured to adjust the conversion scores based on the risk score, a recommendation score for each of the plurality of security authentication flows; selecting, based on the recommendation scores, one of the plurality of security authentication flows; and initiating the selected one of the plurality of security authentication flows to continue the online transaction.

In some aspects, the techniques described herein relate to a system, wherein selecting the one of the plurality of security authentication flows further includes using a third machine learning model that is configured to use a risk tolerance threshold corresponding to an acceptable level of chargeback rates and a transaction abandonment threshold corresponding to an acceptable level of abandoned transactions.

In some aspects, the techniques described herein relate to a system, wherein the third machine learning model is further configured to apply an authentication preference associated with a party of the online transaction for selecting the one of the plurality of security authentication flows.

In some aspects, the techniques described herein relate to a system, wherein selecting the one of the plurality of security authentication flows further includes applying a set of heuristics to eliminate one or more of the plurality of security authentication flows.

In some aspects, the techniques described herein relate to a non-transitory computer-readable medium having stored thereon instructions that are executable by a processor of a computing system to cause the computing system to perform operations including: identifying an online transaction requiring a security authentication; selecting one or more potential security authentication procedures based on transaction data corresponding to the online transaction; determining, using at least one machine learning model, a risk score of the online transaction being fraudulent based on the transaction data; determining, using the at least one machine learning model, a conversion score for the one or more potential security authentication procedures being completed based on the transaction data; evaluating, using the at least one machine learning model, the one or more potential security authentication procedures based on the risk score and the conversion scores; selecting a security authentication procedure from the one or more potential security authentication procedures based on the evaluating; and using the selected security authentication procedure for the online transaction.

In some aspects, the techniques described herein relate to a non-transitory computer-readable medium, wherein selecting the one or more potential security authentication procedures is further based on identifying, using the transaction data, location-based authentication requirements determined from the transaction data.

In some aspects, the techniques described herein relate to a non-transitory computer-readable medium, wherein selecting the one or more potential security authentication procedures is further based on identifying, using the transaction data, exemptions to the location-based authentication requirements.

In some aspects, the techniques described herein relate to a computer-implemented method including: receiving transaction data corresponding to an online transaction having a pending security authentication requirement for one or more authentication factors to process the online transaction; determining, from the transaction data, a risk score corresponding to a probability of the online transaction being fraudulent; calculating, using the transaction data, a conversion score corresponding to a probability of the online transaction being completed with respect to the one or more authentication factors; assessing combinations of the one or more authentication factors for the security authentication requirement based on applying the risk score and the conversion score to determine probabilities of the online transaction being completed with the combinations of the one or more authentication factors; and requesting a combination of authentication factors, selected based on the assessing, to satisfy the security authentication requirement for the online transaction.

In some aspects, the techniques described herein relate to a computer-implemented method, wherein determining the risk score is based on a machine learning model configured to detect fraudulent transaction probabilities.

In some aspects, the techniques described herein relate to a computer-implemented method, wherein the machine learning model is configured to output the risk score based on chargeback fraud binary classification.

In some aspects, the techniques described herein relate to a computer-implemented method, wherein calculating the conversion score is based on a machine learning model configured to determine transaction completion probabilities.

In some aspects, the techniques described herein relate to a computer-implemented method, wherein the machine learning model is configured to output a global conversion score for the one or more authentication factors.

In some aspects, the techniques described herein relate to a computer-implemented method, wherein the machine learning model is configured to output a local conversion score for each of a plurality of security authentication flows that use the one or more authentication factors.

In some aspects, the techniques described herein relate to a computer-implemented method, further including transforming the transaction data for each of the plurality of security authentication flows to calculate the local conversion score for each of the plurality of security authentication flows.

In some aspects, the techniques described herein relate to a computer-implemented method, wherein selecting from the one or more authentication factors further includes selecting, when the risk score exceeds a risk score threshold, a combination of authentication factors associated with a higher security than another combination of authentication factors.

In some aspects, the techniques described herein relate to a computer-implemented method, wherein selecting the combination of authentication factors is further based on selecting, when the risk score is below a risk score threshold, a combination of authentication factors having a higher conversion score than another combination of authentication factors.

In some aspects, the techniques described herein relate to a computer-implemented method, wherein selecting the combination of authentication factors is further based on applying one or more heuristics that are independent from the risk score and the conversion score to filter out one or more combinations of the one or more authentication factors from being selected.

In some aspects, the techniques described herein relate to a computer-implemented method, wherein the one or more heuristics includes filtering out combinations of the one or more authentication factors based on location data associated with the online transaction.

In some aspects, the techniques described herein relate to a computer-implemented method, wherein the one or more heuristics includes filtering out combinations of the one or more authentication factors based on a risk tolerance threshold corresponding to an acceptable level of chargeback rates or a transaction abandonment threshold corresponding to an acceptable level of abandoned transactions.

In some aspects, the techniques described herein relate to a computer-implemented method, further including performing the determining the risk score, the calculating the conversion score, and the assessing the combinations of authentication factors using a machine learning model configured to select the combination of authentication factors from the transaction data.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive transaction data to be transformed, transform the transaction data, output a result of the transformation to recommend an authentication flow, use the result of the transformation to route the authentication flow, and store the result of the transformation to analyze the transaction data. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
detecting a pending security authentication requirement for an online transaction;
predicting, with a first machine learning model using transaction data associated with the online transaction, a risk score of the online transaction being fraudulent;
predicting, with a second machine learning model using the transaction data, a conversion score of the online transaction being completed with each of a plurality of security authentication flows;
predicting, with a third machine learning model configured to adjust the conversion scores based on the risk score, a recommendation score for each of the plurality of security authentication flows;
selecting, based on the recommendation scores, one of the plurality of security authentication flows; and
initiating the selected one of the plurality of security authentication flows to continue the online transaction.

2. The system of claim 1, wherein selecting the one of the plurality of security authentication flows further comprises using a third machine learning model that is configured to use a risk tolerance threshold corresponding to an acceptable level of chargeback rates and a transaction abandonment threshold corresponding to an acceptable level of abandoned transactions.

3. The system of claim 2, wherein the third machine learning model is further configured to apply an authentication preference associated with a party of the online transaction for selecting the one of the plurality of security authentication flows.

4. The system of claim 1, wherein selecting the one of the plurality of security authentication flows further comprises applying a set of heuristics to eliminate one or more of the plurality of security authentication flows.

5. A non-transitory computer-readable medium having stored thereon instructions that are executable by a processor of a computing system to cause the computing system to perform operations comprising:
identifying an online transaction requiring a security authentication;
selecting one or more potential security authentication procedures based on transaction data corresponding to the online transaction;
determining, using at least one machine learning model, a risk score of the online transaction being fraudulent based on the transaction data;
determining, using the at least one machine learning model, a conversion score for the one or more potential security authentication procedures being completed based on the transaction data;
evaluating, using the at least one machine learning model, the one or more potential security authentication procedures based on the risk score and the conversion scores;
selecting a security authentication procedure from the one or more potential security authentication procedures based on the evaluating; and
using the selected security authentication procedure for the online transaction.

6. The non-transitory computer-readable medium of claim 5, wherein selecting the one or more potential security authentication procedures is further based on identifying, using the transaction data, location-based authentication requirements determined from the transaction data.

7. The non-transitory computer-readable medium of claim 6, wherein selecting the one or more potential security authentication procedures is further based on identifying, using the transaction data, exemptions to the location-based authentication requirements.

8. A computer-implemented method comprising:
receiving transaction data corresponding to an online transaction having a pending security authentication requirement for one or more authentication factors to process the online transaction;
determining, from the transaction data, a risk score corresponding to a probability of the online transaction being fraudulent;
calculating, using the transaction data, a conversion score corresponding to a probability of the online transaction being completed with respect to the one or more authentication factors;
assessing combinations of the one or more authentication factors for the security authentication requirement based on applying the risk score and the conversion score to determine probabilities of the online transaction being completed with the combinations of the one or more authentication factors; and
requesting a combination of authentication factors, selected based on the assessing, to satisfy the security authentication requirement for the online transaction.

9. The computer-implemented method of claim 8, wherein determining the risk score is based on a machine learning model configured to detect fraudulent transaction probabilities.

10. The computer-implemented method of claim 9, wherein the machine learning model is configured to output the risk score based on chargeback fraud binary classification.

11. The computer-implemented method of claim 8, wherein calculating the conversion score is based on a machine learning model configured to determine transaction completion probabilities.

12. The computer-implemented method of claim 11, wherein the machine learning model is configured to output a global conversion score for the one or more authentication factors.

13. The computer-implemented method of claim 11, wherein the machine learning model is configured to output a local conversion score for each of a plurality of security authentication flows that use the one or more authentication factors.

14. The computer-implemented method of claim 13, further comprising transforming the transaction data for each of the plurality of security authentication flows to calculate the local conversion score for each of the plurality of security authentication flows.

15. The computer-implemented method of claim 8, wherein selecting from the one or more authentication factors further comprises selecting, when the risk score exceeds a risk score threshold, a combination of authentication factors associated with a higher security than another combination of authentication factors.

16. The computer-implemented method of claim 8, wherein selecting the combination of authentication factors is further based on selecting, when the risk score is below a risk score threshold, a combination of authentication factors having a higher conversion score than another combination of authentication factors.

17. The computer-implemented method of claim 8, wherein selecting the combination of authentication factors is further based on applying one or more heuristics that are independent from the risk score and the conversion score to filter out one or more combinations of the one or more authentication factors from being selected.

18. The computer-implemented method of claim 17, wherein the one or more heuristics includes filtering out combinations of the one or more authentication factors based on location data associated with the online transaction.

19. The computer-implemented method of claim 17, wherein the one or more heuristics includes filtering out combinations of the one or more authentication factors based on a risk tolerance threshold corresponding to an acceptable level of chargeback rates or a transaction abandonment threshold corresponding to an acceptable level of abandoned transactions.

20. The computer-implemented method of claim 8, further comprising performing the determining the risk score, the calculating the conversion score, and the assessing the combinations of authentication factors using a machine learning model configured to select the combination of authentication factors from the transaction data.
